(19) United States
(12) Patent Application Publication
(10) Pub. No.: US 2025/0166659 A1
(43) Pub. Date: May 22, 2025

(54) HUMAN-READABLE EXTREMELY HIGH DENSITY PERMANENT DATA STORAGE

(71) Applicant: BRIGHAM YOUNG UNIVERSITY, Provo, UT (US)

(72) Inventors: Barry Mark Lunt, Provo, UT (US); Matthew R. Linford, Orem, UT (US); Shiuh-hua Wood Chiang, Vineyard, UT (US)

(73) Assignee: BRIGHAM YOUNG UNIVERSITY, Provo, UT (US)

(21) Appl. No.: 18/955,592

(22) Filed: Nov. 21, 2024

Related U.S. Application Data
(60) Provisional application No. 63/601,589, filed on Nov. 21, 2023.

(51) Int. Cl. G11B 7/256; G11B 7/003

(52) U.S. Cl. CPC G11B 7/256; G11B 7/003

(57) ABSTRACT

Disclosed is storage device implemented as an optical tape and having layers. A substrate layer provides resilience to the storage device while a recording stack layer is capable of being inscribed with human-readable information. An optional lubricant layer reduces strain on the storage device as it is both inscribed and read. An optical tape records human-readable information in a small physical area and in a durable medium.

### PRIORITY CLAIM

This application claims the priority and benefit of U.S. Provisional Patent Application No. 63/601,589 filed on Nov. 21, 2023, which is incorporated by reference in its entirety.

### BACKGROUND

The story of humanity has been recorded in many forms since the earliest humans walked the planet Earth. Our current understanding of history tells us that early humans lacked meaningful ways to create formal records. Histories of people and places were taught by spoken word from one generation of people to the next. These histories are largely lost now for many reasons. Oral traditions relied on at least one member of a group memorizing the oral tradition, without error, and teaching it to another person in a later generation. Such traditions relied on the survival of particular people to be passed on from one generation to another. These traditions also required that a person transmit the oral tradition to another without error. And further, these traditions required that the oral tradition be shared with a subsequent generation. Any break in the generational chain led to a complete loss of the oral history of the group.

Over time, language developed such that thoughts and spoken words could be expressed in a written form. Sumerian cuneiform is currently the oldest known written language, which is a series of wedge shaped marks carved into clay tablets. Egyptian hieroglyphs were also an ancient form of written language, which was both carved into various media, such as stones and wood, but was also painted and written on stones, papyrus, and painted, carved, or cast into metal. History knows about these languages and writing systems because some examples of written cuneiform and hieroglyphs survived through time to today. Ancient peoples realized that written language was a far better way to record their stories and history than passing histories from one generation to the next orally. With the advent of written language, oral histories were, in some cases, transcribed into written histories that could endure longer than their human carriers would live.

For thousands of years, humans relied on written texts to write their histories though methods other than carving, casting, and painting were developed. For example, new writing surfaces were invented, such as parchment and paper which were far easier to store than stone tablets. Many of the histories written on stone tablets were transcribed into a new format on paper or parchment to continue the history of people. In other words, as the storage medium for written language transformed from clay and stone to parchment and paper, written language was easier to store for many civilizations. Libraries were created to care for and maintain these records to maintain all of the histories that could be maintained.

Paper and parchment, in ancient times, were expensive commodities. Frequently, only one version of a book or a history was created and maintained in a library or a personal collection. Further, and unfortunately, paper and parchment are far less durable than stone. Fires and floods through years upon years of history destroyed many libraries and many histories that were the only ones of their kind, resulting in histories that were lost forever. While many parchment and paper books and histories did survive, many have been edited, mis-translated, mis-transcribed, or incorrectly interpreted for various reasons, including negligence, intentional changes, incompetence, and in some cases malevolence during re-transcription due to aging of the parchment and paper books. Other books and histories were censored for their content, in many cases. In either case, information in these documents was lost.

With the invention of the printing press, books became much easier to print in quantity which increased the likelihood of survival for many books. And, until very recently, printed books were how humans stored their histories and stories. When the transistor was invented, digital storage became a reality. Digital storage solved many of the storage issues for information. Instead of needing great buildings to house paper and parchment, a single memory storage could maintain more information than ever was stored in those great buildings and made that information accessible to anyone who desired access to it. Digital storage on magnetic tapes and disks, optical storage discs, semiconductor storage, and solid state storage media require little physical space to store high volumes of information.

Digital storage was as transformative to information storage as paper and parchment were to clay tablets. Digital storage has made information of any kind simple to obtain through the Internet, which was not possible even 50 years ago. More written information is generated now than has ever been generated in the history of humanity. While digital storage has had a massive effect on humanity, digital storage is still limited. For example, information stored in digital storage devices, are encoded, and stored in a manner that is virtually incomprehensible to all but the most technologically savvy of human beings, if that information could be obtained by those human beings at all. The weakness of digital storage is that digital storage requires machines to pull the stored information and provide it to a human being in a human-readable format. A human being cannot simply read information contained on an optical disc or a magnetic disk without a machine that is programmed to transfer different elements of the optical disc or magnetic disk into a human-readable form. For this reason, more than the simple storage of digital information is necessary to maintain digital information. The machines programmed to read digital information must also be maintained to provide a meaningful storage of information that can last through time. Digital information within a device that cannot access power or is somehow damaged, may be unrecoverable.

For this reason, there is a need to store information in a physically small footprint or package while also maintaining the information in a human readable form. To solve this need, a new type of storage medium is required that does not require a machine that must also be maintained and allows the information to be stored in a human-readable form.

It is therefore one object of this disclosure to provide a storage device having a small physical footprint while also storing information in a human readable format. It is further an object of this disclosure to provide a storage device which contains storage media that is both human readable, readily replicated, and easily stored.

### SUMMARY OF THE DISCLOSURE

Disclosed herein is a storage device implemented as an optical tape with a plurality of layers. The layers include a substrate layer, a recording stack layer, and a lubricant layer.

Further disclosed herein is an optical tape device which includes a substrate layer, a recording stack layer, and a lubricant layer.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a prior art storage device for storing magnetically encoded information.

FIG. 2 illustrates a storage device in an empty state.

FIG. 3 illustrates the storage device of FIG. 2 with information contained within the storage device.

### DETAILED DESCRIPTION

In the following description of the disclosure, reference is made to the accompanying drawings, which form a part hereof, and which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

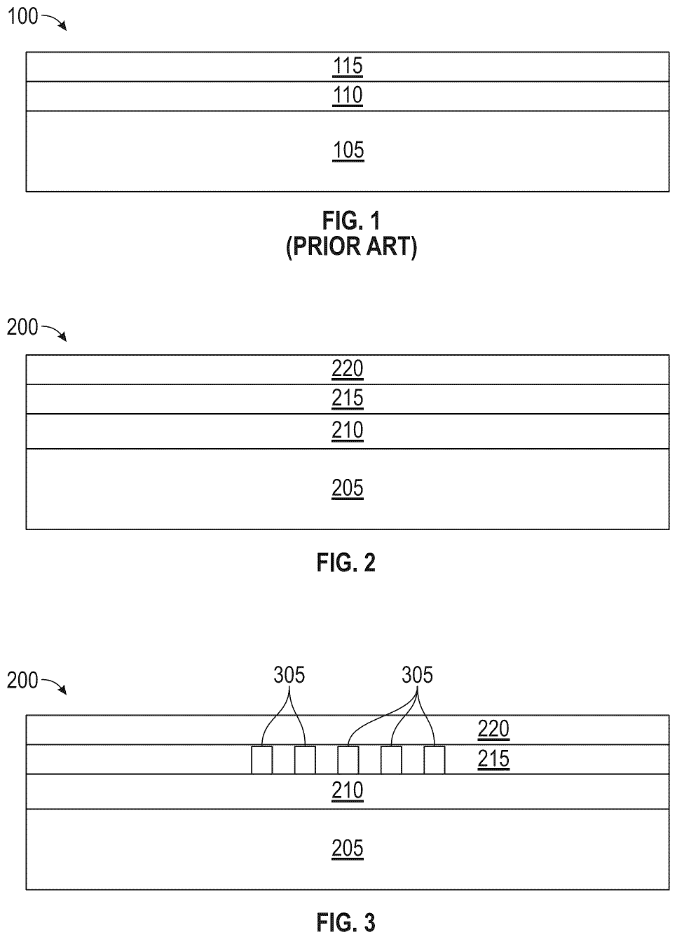

FIG. 1 illustrates a prior art storage device 100 for storing magnetically encoded information. Storage device 100 may be magnetic tape, which is used in cassette tapes, VHS video tapes, and reel-to-reel tapes. Storage device 100 may include a layer 105 made of polyethylene terephthalate (PET), also known as Mylar® in the relevant industries. Layer 105 may have a thickness of approximately 0.03 mm as conventionally known for magnetic tapes of this type. A magnetic layer 110 may be disposed on PET layer 105, which serves to record information in a magnetically encoded manner. Magnetic layer 110 may have a thickness of approximately 50 nanometers, give or take a manufacturing tolerance of 5%. A lubricant layer 115 may be disposed on magnetic layer 110 to provide mechanical lubrication for the magnetic encoding/decoding device. Lubrication layer 115 may have a thickness of approximately 25 nanometers, give or take a manufacturing tolerance of 5%.

In use, storage device 100, a magnetic tape, is placed in contact with a recording head of an electronic device. Various fixtures, such as plastic in the form of a cassette, VHS cassette, 8-Track cassette, reel, or similar fixture, may hold storage device 100 and allow magnetic tape to transfer from one reel to another as the magnetic tape is drawn over the recording head for either recording information, reading information, or encoding new information on the magnetic tape. Lubricant layer 115 allows the magnetic tape to come into contact with and slide over the recording head of the electronic device without catching on the recording head to record information, read information, or encode new information on the magnetic tape. A recording head may create a fluctuating magnetic field which causes the magnetic tape to respond by maintaining a section of the magnetic tape exposed to the magnetic field. A series of magnetic portions of the magnetic tape encode information which is subsequently readable by the recording head. Other types of recording techniques, such as heat assisted magnetic recording (“HAMR”) use a laser in the recording head to heat the recording layer and provide higher fidelity and storage capacity in a magnetic tape, with the benefit of using a magnetic field of reduced strength to encode information on the magnetic tape.

FIG. 2 illustrates a storage device 200 which may be an optical tape, in an empty state and having characteristics similar to that of a magnetic tape, but without a magnetic layer 110 for storing encoded information, discussed above. As shown in FIG. 2, storage device 200 includes a substrate layer 205 which may be made from PET. Storage device 200 may also be manufactured using polyimide for greater longevity and polytetrafluoroethylene, among others known to those of skill in the art. Substrate layer 205 may have a thickness of approximately 0.03 millimeters, depending on manufacturing tolerances of up to 5%. Substrate layer 205 acts as a resilient layer which operates as a base for an optical tape, implemented as storage device 200. Storage device may be created using standard tape sizes, such as ¼ inch widths, ½ inch widths, and 8 millimeter widths (used in cassette tapes, VHS cassette tapes, and 8-Track tapes, for example). Storage device 200 may be implemented as tape that may be disposed in a plastic housing, such as cartridges for a cassette tape, VHS tape, 8-Track tape, tape reels, etc.

Storage device 200 may further include an optional adhesion promotion layer 210. Adhesion promotion layer 210 may be disposed on a substrate layer 205 to promote adhesion or connection between substrate layer 205 and other layers of storage device 200, discussed below. Adhesion promotion layer 210 may be implemented as a layer of adhesive compound which may be chemical or heat activated to form an adhesive connection between substrate layer 205 and other layers of storage device 200, which will be discussed below. Adhesion promotion layer may have a thickness of approximately 1 micrometer based on manufacturing tolerances of 5%. Adhesion promotion layer 210 may further be optional and included as needed to secure recording stack layer 215 to substrate layer 210 (or, to secure recording stack layer 215 to adhesion promotion layer 210 which is secured to substrate layer 210) based on the implementation of recording stack layer 215.

Recording stack layer 215 may further be implemented in storage device 200 and connected directly to substrate layer 210 or indirectly by optional adhesion promotion layer 210. Recording stack layer 215 may have a thickness of approximately 10-50 nanometers, depending on implementation and manufacturing tolerances. Recording stack layer 215 may be responsive to high resolution energy beams such as an electron beam (“e-beam”), a Focused Ion Beam (“FIB”) lasers, or similar high-resolution energy beams. Recording stack layer 215 may include constituent layers (e.g., sub-layers) of materials such as a thin metallic layer between protective layers, for example. The constituent layers of materials of recording stack layer 215 may receive energy or force from an e-beam, FIB or an atomic force microscope tip (“AFM”)/atomic tunneling microscope tip (“ATM”) and react by characters which are inscribed into recording stack layer 215. In other words, recording stack layer 215 may be physically inscribed with permanent markings that may be read optically by a human (using magnification, as will be discussed below).

Recording stack layer 215 is not limited to being inscribed with characters and may receive any human-readable information, as desired. In some cases, as will be discussed below, certain printing techniques may be used to provide color printing on recording stack layer 215, which includes the ability to record pictures or other visual representations on recording stack layer 215. In the case of characters, and by way of example, an e-beam or FIB may write characters on recording stack layer 215 that have a character size of 100 nanometers. In such a scenario, storage device 200 implemented in a single linear tape open data tape would be sufficient to store the entire contents of the United States Library of Congress, which holds approximately 167 million volumes. Whether force is used by an AFM/ATM tip or an energy is used by an e-beam/FIB, recording stack layer 215 may be inscribed with human readable information, characters, and visual representations, such as pictures without reliance on magnetism. Recording stack layer 215 may be non-magnetic and implemented using non-magnetic and highly ductile metals such as gold, silver, copper, other metals such as nickel, chrome, aluminum and others known in the art, metal alloys or certain types of plastics and films.

Storage device 200 may further include an optional lubricant layer 220 disposed on top of recording stack layer 215. Lubricant layer 220 may provide lubrication, if required, during reading of information inscribed in recording stack layer 215. Lubricant layer 220 allows storage device 200 to slide easily across, for example, a microscope, while decreasing stress and strain on substrate layer 205 that may otherwise be caused by friction.

FIG. 3 illustrates storage device 200 of FIG. 2 with information contained within storage device 200. As discussed with respect to FIG. 2, storage device 200 includes a substrate layer 205, an optional adhesion promotion layer 210, a recording stack layer 215, and an optional lubricant layer 220. Storage device 200 is implemented as an optical and non-magnetic tape which may be inscribed by e-beam, FIB, AFM, or ATM technology to include permanent markings in recording stack layer 215. As shown in FIG. 3, permanent markings 305 are inscribed into recording stack layer 215. Permanent markings 305 may be representative of characters, which include Latin characters, Chinese characters, Japanese characters, Korean characters, Cyrillic characters, Arabic characters, or any other characters which are part of a written human language, or any other characters intended to convey meaning. For example, an e-beam or FIB may be used to apply focused energy into recording stack layer 215 to permanently inscribe characters or information into recording stack layer 215. An AFM or ATM tip may use force applied to recording stack layer 215 to permanently inscribe characters or information into recording stack layer 215.

Using these techniques, recording stack layer 215 may be inscribed with analog information. The analog information may be inscribed in a monochromatic fashion, although various gray scales may be applied by variations in beam width or spot sizes applied by an e-beam or FIB. Halftone printing processes, which are known to those of skill in the art in the context of creating black and white images for newspapers, may also be used to provide monochromatic inscriptions on recording stack layer 215. In some cases, using a 3-color separation and halftone printing techniques, and an appropriate readback combiner, a full color inscription may be inscribed into recording stack 210, facilitating analog recordation of pictures, images, or other visual representations.

Once permanent markings 305 are inscribed within recording stack layer 215, they may be read by humans using optical magnification. The use of optical magnification is considered to still be “human-readable” for the purposes of this disclosure. While advanced microscopes, such as a scanning electron microscope (“SEM”), a transmission electron microscope (“TEM”), or an electronic optical microscope may be easier to use for reading permanent markings 305 in recording stack layer 215, simple optical magnification may also be sufficient to read permanent markings 305 in recording stack layer 215, rendering the permanent markings 305 “human-readable” without reliance on a particular machine which may not exist in the future. It is anticipated that storage device could be human-readable for 1000 years or more.

Simple optical magnification techniques render permanent markings 305 intelligible whether advanced microscope technology is available in the future or not. Further, while storage device 200 would maintain usefulness for an amount of time similar to an optical disc, the information inscribed in storage device 200 is stored in an analog human-readable fashion that does not require a specific machine, like an optical disc reader.

Although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A storage device, the device comprising:
an optical tape having a plurality of layers, including:
a substrate layer; and
a recording stack layer.

2. The storage device of claim 1, further comprising an adhesion promotion layer.

3. The storage device of claim 2, wherein the adhesion promotion layer is disposed on the substrate layer.

4. The storage device of claim 3, wherein the recording stack layer is disposed on the adhesion promotion layer.

5. The storage device of claim 1, wherein the recording stack layer is disposed on the substrate layer.

6. The storage device of claim 1, further comprising a lubricant layer disposed on the recording stack layer.

7. The storage device of claim 1, wherein the recording stack layer includes at least one sub-layer.

8. The storage device of claim 7, wherein the at least one sub-layer is a metal layer.

9. The storage device of claim 7, wherein the at least one sub-layer is a metal alloy layer.

10. The storage device of claim 1, wherein the recording stack layer is non-magnetic.

11. An optical tape device, the device comprising:
a substrate layer; and
a recording stack layer.

12. The optical tape device of claim 11, further comprising an adhesion promotion layer.

13. The optical tape device of claim 12, wherein the adhesion promotion layer is disposed on the substrate layer.

14. The optical tape device of claim 13, wherein the recording stack layer is disposed on the adhesion promotion layer.

15. The optical tape device of claim 11, wherein the recording stack layer is disposed on the substrate layer.

16. The optical tape device of claim 11, further comprising a lubricant layer disposed on the recording stack layer.

17. The optical tape device of claim 11, wherein the recording stack layer includes at least one sub-layer.

18. The optical tape device of claim 17, wherein the at least one sub-layer is a metal layer.

19. The optical tape device of claim 17, wherein the at least one sub-layer is a metal alloy layer.

20. The optical tape device of claim 11, wherein the recording stack layer is capable of being physically inscribed with human-readable information.
